(19) United States
(12) Patent Application Publication
(10) Pub. No.: US 2025/0030542 A1
(43) Pub. Date: Jan. 23, 2025

(54) REPLICATION OF CUSTOMER KEYS STORED IN A VIRTUAL VAULT

(71) Applicant: Oracle International Corporation, Redwood Shores, CA (US)

(72) Inventors: Frederick Bosco, Portland, OR (US); Hanyue Zhang, Seattle, WA (US); Rakesh Ganimini Baskar, Bellevue, WA (US); Ankit Goyal, Redmond, WA (US); Danyu Yang, Woodinville, WA (US)

(73) Assignee: Oracle International Corporation, Redwood Shores, CA (US)

(21) Appl. No.: 18/778,722

(22) Filed: Jul. 19, 2024

Related U.S. Application Data
(60) Provisional application No. 63/528,176, filed on Jul. 21, 2023.

(51) Int. Cl. H04L 9/08; H04L 9/14

(52) U.S. Cl. CPC H04L 9/0894; H04L 9/14

(57) ABSTRACT

Techniques are described for replicating encryption keys using a write ahead log (WAL). An example method can include receiving a request from a user device to transmit encryption keys stored in a first virtual vault of a first hardware security module (HSM) of a first data center to a second virtual vault of a second HSM of a second data center, the request comprising an account identifier. The method can further include identifying a first account-specific WAL of a plurality of account-specific WALs based at least in part on the account identifier, each account-specific WAL corresponding to the first HSM, and configured to record changes to a respective virtual vault of the plurality of virtual vaults. The method can further include accessing the encryption keys from the first account-specific WAL of the first HSM. The method can further include transmitting the encryption keys to the second data center.

### CROSS-REFERENCE TO RELATED APPLICATIONS

This application claims the benefit and priority of U.S. Provisional Application No. 63/528,176, filed on Jul. 21, 2023, which is incorporated by reference herein in its entirety for all purposes.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others.

A CSP service can include a key management service (KMS) that manages encryption keys on behalf of a CSP customer. The customer can use the encryption keys to access one or more CSP resources for performing computing tasks on the CSP's platform.

### BRIEF SUMMARY

Embodiments herein describe techniques for replicating encryption keys at a primary region and transmitting the replicated encryption keys to a secondary region. A cloud service provider (CSP) can set up a customer-specific write-ahead log (WAL) at the primary region. Each time that a client-agnostic encryption storage is updated by a customer, the customer-specific WAL can record only those updates related to the particular customer. Then, if the customer wants to store the encryption keys at the secondary region, the CSP can access the customer-specific WAL that only stores the customer's encryption keys, rather than the storage, which may store multiple different customers' keys.

Various embodiments are described herein, including computer-implemented methods, systems, non-transitory computer-readable media storing programs, code, or instructions executable by one or more processors, and the like. Some embodiments may be implemented by using a computer program product, comprising program/instructions which, when executed by a processor, cause the processor to perform any of the methods described in the disclosure.

Embodiments herein are directed toward techniques for replicating encryption keys using a write ahead log, wherein a technique can include, for example, a method, a computing system, or one or more computer readable media. An example method can include a computing system receiving a request from a user device to transmit encryption keys stored in a first virtual vault of a plurality of virtual vaults of a first hardware security module (HSM) of a first data center to a second virtual vault of a second hardware security module (HSM) of a second data center, the request comprising an account identifier.

The method can further include the computing system identifying a first account-specific write-ahead log (WAL) of a plurality of account-specific write-ahead logs (WALs) based at least in part on the account identifier, each account-specific write-ahead log (WAL) of the plurality of account-specific write-ahead logs (WALs) corresponding to the first hardware security module (HSM), and each account-specific write-ahead log (WAL) of the plurality of account-specific write-ahead logs (WALs) configured to record changes to a respective virtual vault of the plurality of virtual vaults.

The method can further include the computing system accessing the encryption keys from the first account-specific write-ahead log (WAL) of the first hardware security module (HSM).

The method can further include the computing system transmitting the encryption keys to the second data center based at least in part on accessing the encryption keys from the account-specific write-ahead log (WAL).

### BRIEF DESCRIPTION OF THE DRAWINGS

FIG. 1 is an illustration of a system for replicating encryption keys stored in a virtual vault, according to one or more embodiments.

FIG. 2 is an illustration of a hardware security module (HSM) write-ahead log (WAL), according to one or more embodiments.

FIG. 3 is an illustration of a system for replicating encryption keys stored in a virtual vault in a primary region, according to one or more embodiments.

FIG. 4 is an illustration of a system for storing encryption keys stored in a virtual vault in a secondary region, according to one or more embodiments.

FIG. 5 is a signaling diagram for replicating keys from a primary region to a secondary region, according to one or more embodiments.

FIG. 6 is a process for replicating keys from a primary region to a secondary region, according to one or more embodiments.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A cloud services provider (CSP) can offer a key management service (KMS) to its customers to manage and use encryption keys for integrating with other CSP-managed services, such as a database service, an object storage, or other CSP-managed service. Each encryption key can be a logical entity that include cryptographic material for safeguarding data. In some instances, the CSP can operate data centers that are located in different regions. From time to time, a customer may desire to replicate its encryption keys that are stored in one region (e.g., a primary region) and store the replicated encryption keys in another region (e.g., a secondary region). For example, the customer may have encryption keys stored in a data center in Ashburn, VA, and desire to have a replicated keys stored in a data center in Phoenix, AR, to have a backup set of encryption keys. Alternatively, this could occur if the customer wants to run respective service instances in different regions.

To accommodate a customer's request to replicate encryption keys and store them in another region, conventional CSPs have used various techniques. One example of a conventional technique used by CSPs is to replicate all of the encryption keys stored in a primary region and store them in a secondary region. In this approach, the CSP can access a virtual vault in a data center in one region. The CSP can then replicate all of the encryption keys stored in the virtual vault and store them in another virtual vault in another region. One drawback to this approach can be that multiple customers can have their encryption keys stored in the virtual vault at the primary region. Therefore, the technique can lead to customers who have not asked for their encryption keys to be replicated and stored elsewhere having their encryption keys replicated and stored in the secondary region. Another example of a conventional technique is to store encryption keys in a virtual private vault, which is only used by a single customer. In this approach, a CSP can replicate the encryption keys stored in the virtual private vault in a data center in the primary region and store the replicated encryption keys in another virtual private vault in the secondary region. One drawback to this approach can be that the virtual private vaults can be costly to maintain, as they require dedicated software and hardware at both the primary region and the secondary region.

Embodiments described herein address the above-referenced issues by providing techniques for generating customer-specific write-ahead logs (WALs) that store the customer's encryption keys. A CSP can write an encryption key for a customer and store the encryption key in a customer-specific virtual vault at a primary region. The customer-specific virtual vault can have a one-to-one correspondence with a customer-specific WAL. Each time that data (e.g., an encryption key) stored in the virtual vault is changed (e.g., added to, modified at, or removed from), the WAL can have a record of the change. Therefore, the WAL can include a current state of the data in the virtual vault.

The virtual vault can be associated with a partition, which can be a physical partition or a virtual partition of storage of a hardware security module (HSM). The HSM can be a physical device that is configured to provide secure management, processing, a storage of encryption keys. For example, the HSM can be a card that is slotted into a server in a data center. Both the encryption key and the WAL can be stored in the partition. At some point, a customer may transmit a request to the CSP to move the encryption keys in the partition to a secondary region. Even though the partition may include encryption keys for more than one customer (e.g., multiple virtual vaults and WALs), each WAL is customer-specific and only includes encryption keys for the customer requesting that the encryption keys be moved to the secondary region. In this sense, the WAL can act similarly to a virtual partition for the customer's encryption keys. Based on the request, the CSP can replicate the WAL at the secondary region, and store the encryption keys in the WAL in a partition on an HSM at the secondary region.

The embodiments herein provide several technical advantages over conventional methods. The embodiments herein use fewer computing resources, while still being able to accommodate customer specific requests. As indicated above, virtual private vaults can be costly to maintain. However, the herein-described customer-specific WAL can be maintained with fewer computing resources than needed for the virtual private vault and still be used to only transmit customer-specific encryption keys. Another technical advantage is that the embodiments herein can be used to transmit customer-specific keys from a partition. As described above, the conventional methods replicate all of the keys in a partition regardless of customer. Therefore, customers who do not ask for their keys to be replicated still have their keys replicated and stored in a secondary region. The embodiments herein describe techniques for replicating encryption keys from a WAL, which acts as a virtual partition for the customer. Therefore, the CSP can replicate only those encryption keys that have been requested to be replicated by a customer. By only replicating the requested encryption keys, the CSP can save computing resources and time.

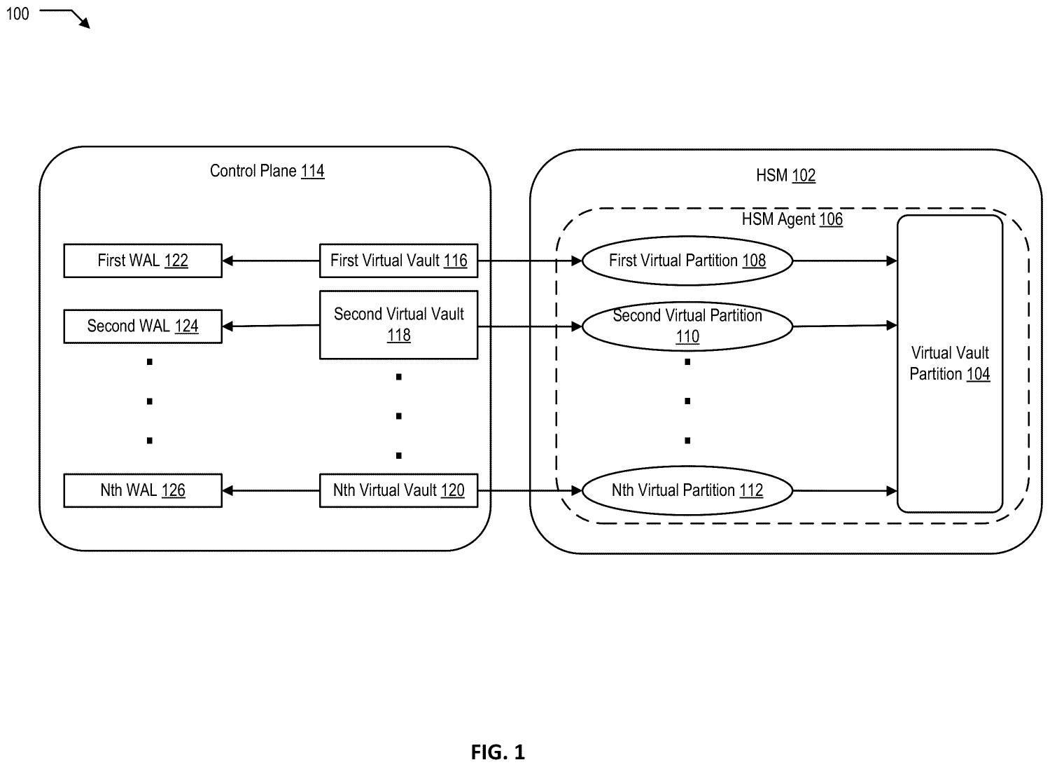

FIG. 1 is an illustration 100 of a virtual partition, according to one or more embodiments. A virtual partition can be a logical partition at an HSM that is assigned to a virtual vault. The virtual vault can have a one-to-one mapping to a virtual partition. Multiple virtual partitions can be mapped to a virtual vault partition (e.g., a physical partition) of an HSM. The HSM can be used at a data center in a region of a CSP. Therefore, each virtual partition may be mapped to a single physical partition in a region. As indicated above, an HSM 102 can be a physical device that is configured to provide secure management, processing, and the storage of encryption keys. The HSM 102 can reside in a data center location in a first region (e.g., a primary region). For example, the HSM 102 can be an HSM card that is slotted into a server at the data center.

A customer's encryption keys can be stored on a physical partition of the HSM 102, where the physical partition can be a defined segment of the HSM's physical storage. The HSM 102 can provide various security features for safeguarding a customer's encryption keys. For example, any encryption key that is exported from the HSM 102 can only be imported into another HSM that has the same owner as the HSM 102. An HSM vendor can install a vendor certificate on each HSM that it distributes, where the vendor can be the same as the HSM manufacturer. The vendor can further install HSM-level encryption key during a manufacturing process, in which the encryption key can be a vendor fixed key. Furthermore, the CSP can install a CSP certificate on each HSM that it purchases. The CSP can further install an HSM-level encryption key for the HSM, which can be a master crypto office fixed key (MCO fixed key).

In the event that a customer's encryption keys are exported out of the HSM, the exported encryption keys can be encrypted using the MCO fixed key. In some embodiments, individual physical partitions within the HSM 102 can be secured using a respective partition crypto officer fixed key (PCO fixed key). The HSM 102 can further derive a key backup key (KBK) using the vendor fixed key, the MCO fixed key, and optionally the PCO fixed key as inputs for a key derivation function that generates the KBK. The KBK can be used in the event of the loss of corruption of the vendor fixed key, the MCO fixed key, and, if used, the PCO fixed key. This can ensure that any key backup can only be restored onto the HSM with the same ownership (e.g., vendor and CSP) and KBK.

The HSM can also create a masking key, which is a random key that is generated each time that a new partition is created in the HSM. The masking key can be a partition-specific key and be stored in the partition. If an encryption key that is stored in the partition is to be exported from the partition, the HSM 102 can use the masking key to encrypt the encryption key. It should be appreciated that the KBK can be derived using the PCO fixed key, whereas the masking key can be generated by the HSM without any predetermined keys as inputs. As such, an exported encryption key that has been encrypted using the masking key can only be imported back into the partition that uses the same masking key. In some instances, a CSP can use the same seed value for a key derivation algorithm to generate the same masking keys in different partitions at different HSMs.

In the event that encryption keys are imported into an HSM, the encryption keys can be authenticated using the masking key, the MCO fixed key, the vendor ownership information (e.g., vendor certificate, vendor fixed key), and CSP ownership information (CSP certificate).

The HSM 102 can include a virtual vault partition 104, which can include a defined segment of the HSM's physical storage. The virtual vault partition 104 can include its own file system for organizing the encryption keys. The virtual vault partition 104 can be used to store encryption keys belonging to a CSP's customers. The virtual vault partition 106 can be managed by an HSM agent 106. The HSM agent 106 can include a service that manages one or more HSMs at a data center. The HSM agent 106 can execute on a server external to the HSM 102. For example, if the HSM 102 is a card slotted onto a server, the HSM agent 106 can execute on the server. As illustrated, multiple virtual partitions (e.g., first virtual partition 108, second virtual partition 110, and Nth virtual partition 112) are mapped to the virtual vault partition 104. Each virtual partition can be customer-specific and map to a particular customer's encryption keys in the virtual vault partition 104. Each virtual partition can include a respective identifier for distinguishing one virtual partition from another virtual partition. For example, each vault virtual partition can use a vault prefix as an identifier.

Each virtual partition can be mapped to a respective virtual vault in a control plane 114 of the data center at the first region. A virtual vault can include a vault that shares a partition (e.g., virtual vault partition). For example, the control plane 114 can include a first virtual vault 116, a second virtual vault 118, and an Nth virtual vault 120. Each virtual vault can be customer-specific and store the customer's encryption keys. As illustrated, each virtual vault in the control plane can have a one on one mapping to a virtual partition. For example, the first virtual vault 116 can be mapped to the first virtual partition 108, the second virtual vault 118 can be mapped to the second virtual partition 110, and the Nth virtual vault 120 can be mapped to the Nth partition 112. It can further be seen that each of the virtual partitions can be mapped to the same virtual vault partition 104. Therefore, each of the virtual vaults can be mapped to the same virtual vault partition 104. The virtual vaults can include, for example, customer-specific encryption keys. The virtual partitions can include, for example, metadata for accessing the virtual vault partition. For example, the virtual partition can include metadata that includes a memory address for memory in the virtual vault partition 104 that corresponds to a virtual vault.

Each virtual vault can be mapped to a respective control plane/data plane CPDP write-ahead log (WAL). A WAL can include a sequential log of each update that occurs in a corresponding virtual vault. For example, each time that an encryption key is inserted into a virtual vault, the WAL can be updated to also include the inserted encryption key. Additionally, each time an encryption key is removed from a virtual vault, the WAL can include an indication that the encryption key was removed. Further each time that an encryption key is modified in a virtual vault, the WAL can include the modification. In some instances, a log entry is added to the WAL prior to the update being made at the corresponding virtual vault. The log entry can include information that can be used to reproduce the change at the virtual vault, including an operation type (e.g., insert, modify, delete), the encryption keys to be updated, and associated metadata. Once the virtual vault has been updated, the log entry at the WAL can be updated to indicate that the update is complete.

The WAL can include several components, such as log entries, a log buffer, a log sequence number (LSN), a WAL file, a checkpointing system, and a recovery manager. In the event that there is an update of the virtual vault, the update can first be written into a log buffer in the HSM's memory. The LSN can be used to order the log entries to make sure that any updates to the virtual vault are made in the same order. In some instances, a checking system can remove the log entries from the HSM's memory and can cause the log entries to be written to a WAL file on a disk.

As illustrated, the first WAL 122 maps to the first virtual vault 116. Therefore, each update of the data stored in the first virtual vault 116 can be an update in the first WAL 122. It is additionally illustrated that the second WAL 124 can map to the second virtual vault 118, and the Nth WAL 126 can map to the Nth virtual vault 120. Each WAL can be a customer-specific WAL, such that updates at one customer's virtual vault are not reflected in a WAL associated with another customer. The first WAL 122, the second WAL 124, and the Nth WAL 126 can reside in the control plane of a data center in the first region. Each WAL at the control plane 114 can include a replication of the contents of a corresponding virtual vault. For example, the contents of the first WAL 122 can include a replication of the contents of the first virtual vault 108. As illustrated, multiple customers can have their encryption keys securely stored in a virtual vault partition 104 in one region (e.g., a primary region). Furthermore, in the event that one customer wants their encryption keys to be also stored in another region (e.g., a secondary region), the CSP does not need to replicate all of the encryption keys in the virtual vault partition 104. Rather, the CSP can determine which WAL is associated with a customer who wants their encryption keys replicated at another region and access that WAL. The CSP can then replicate the encryption keys stored in the WAL, and transmit the replicated encryption keys to the desired region.

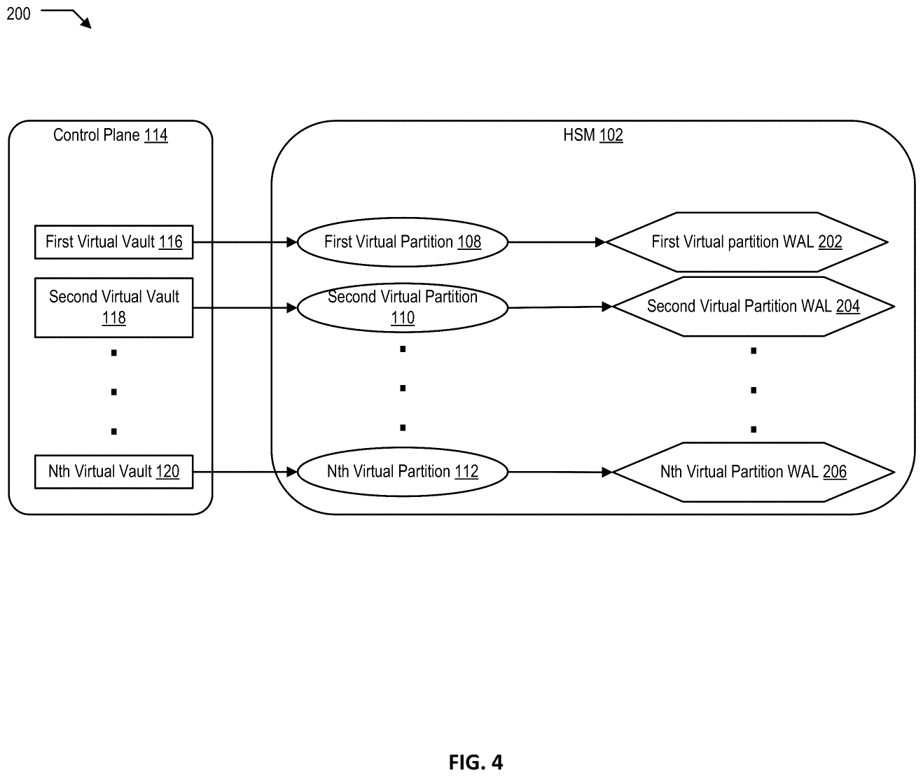

FIG. 2 is an illustration 200 for an HSM WAL, according to one or more embodiments. As described with respect to FIG. 1, vault-specific virtual vaults (e.g., first virtual vault 116, second virtual vault 118, and Nth virtual vault 120) can be mapped to respective virtual partitions (e.g., first virtual partition 108, second virtual partition 110, and Nth virtual partition 112). As indicated above, the CPDP replication WALs (e.g., first WAL 122, second WAL 124, and Nth WAL 126) can be created at a control plane 114 of a data center in the first region.

The HSM WALs can be created at the HSM 102. For example, if an HSM agent (e.g., HSM agent 106) that manages the HSM 102 causes the virtual partitions to be created at the HSM 102, the HSM agent can further cause the creation of virtual partition WALS at the HSM 102. As illustrated, each virtual partition WAL (e.g., first virtual partition WAL 202, second virtual partition WAL 204, and Nth virtual partition WAL 206) can have a one-to-one correspondence with a virtual partition. Each of these WALs at the HSM 102 can include a replication of the contents of a corresponding virtual partition. For example, the contents of the first virtual partition WAL 202 can be a replication of the contents of the first virtual partition 108. The contents of the second virtual partition WAL 204 can be a replication of the contents of the second virtual partition 110. The contents of the Nth virtual partition WAL 206 can be a replication of the contents of the Nth virtual partition 112.

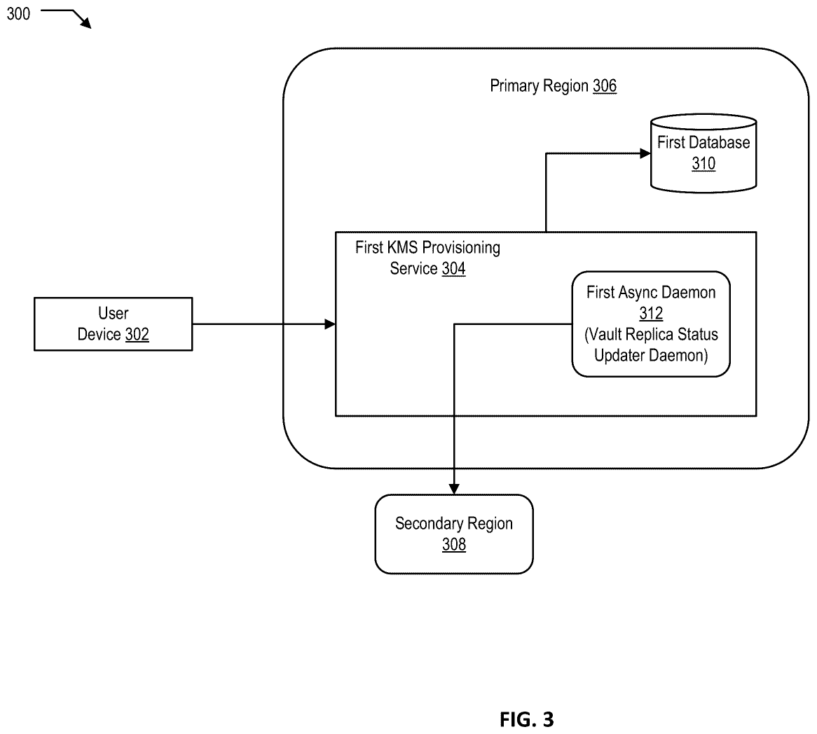

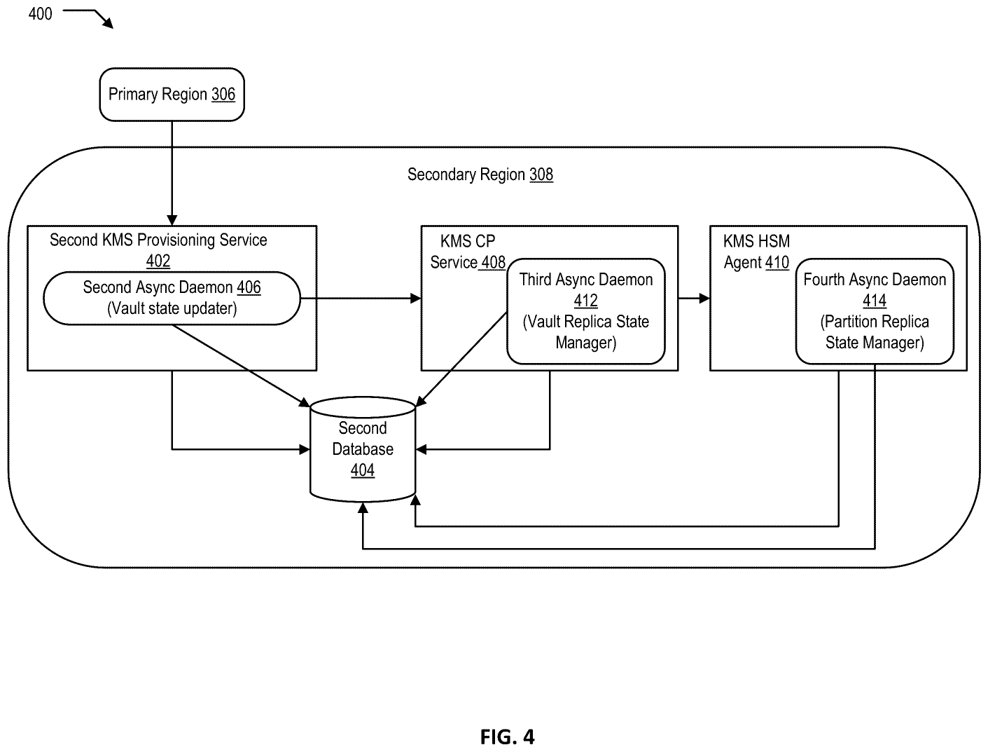

The WALS, virtual vaults, and virtual partitions described above can be used to replace encryption keys stored on an HSM at a first region, onto an HSM at a second region. A general description for replicating encryption from one region to another region is provided below. A more detailed explanation for replicating encryption keys from one region to another region is provided with respect to FIGS. 3 and 4.

A customer can use a computing device to transmit a request to a center at a first region (e.g., primary region). The customer can request to replicate encryption keys stored at the first region and store the replicated encryption keys at a secondary region (e.g., secondary region 308). The encryption keys can be stored in a virtual partition WAL of a first HSM (e.g., HSM 102) at a first data center in the first region. A computing process at the first data center in the first region can communicate with a computing process at a second data center in the second region. At the second data center, the computing process can make a call to an HSM agent that manages a second HSM at the second data center. The call can include a request to create a virtual partition at the second HSM. The HSM agent can transmit a request to the HSM to create a virtual vault that maps to a virtual vault partition at the second HSM. The request can be logged into a database that is associated with the second HSM. A first backend process (e.g., an HSM partition state manager) at the second data center can access the request to create the virtual vault from the database. The first backend process can create a virtual partition, and then create a mapping between the virtual partition and a virtual vault partition (e.g., segmented physical storage) in the HSM. A second backend process (e.g., a vault state manager) can wait until the virtual vault is created. Once the virtual vault is created, the second backend process can then generate vault keys (e.g., wrapping keys and intermediate encryption keys), which can be used to protect any encryption keys that will be stored in the virtual vault. The second backend process can then indicate that the virtual vault and the vault keys have been generated. For example, the data center and the secondary region can include a second database that stores a record of the creation of the virtual vault. The second backend process can store the indication that the vault and the vault keys have been created in the second database.

An HSM agent that manages the second HSM can cause the creation of a virtual partition that corresponds to a virtual vault partition of the second HSM. The virtual vault partition can be customer-specific for storing the customer's encryption keys. Once the virtual vault is created, the HSM agent can further cause the creation of a virtual partition WAL that corresponds to the virtual partition. The virtual partition WAL can be configured such that each time that the contents of the virtual partition have been updated, the virtual partition WAL records the updating (e.g., adding encryption keys, modifying encryption keys, deleting encryption keys).

Once the virtual partition and the virtual partition WAL are generated, the HSM agent can cause the encryption keys to be stored at the primary region. For example, the encryption keys can be stored in a virtual partition WAL (e.g., first virtual partition WAL 202, second virtual partition WAL 204, and Nth virtual partition WAL 206) at an HSM in the primary region. The HSM agent can cause these encryption keys to be replicated and stored in the newly created virtual partition WAL at the HSM in the secondary region.

FIGS. 3 and 4 can be viewed together and are provided to illustrate a process for replicating encryption keys in a primary region and storing the replication encryption keys in a secondary region. FIG. 4 can be viewed as a continuation of FIG. 3. FIG. 3 is an illustration 300 of a system for replicating encryption keys stored in a virtual vault in a primary region, according to one or more embodiments. FIG. 4 is an illustration 400 of a system for storing encryption keys stored in a virtual vault in a secondary region, according to one or more embodiments.

A user device 302 can transmit a request to a KMS provisioning service 304 in the primary region 3056 to create a vault for customer's encrypted keys in the secondary region. For example, the user device 302 can be the customer's device and be used to access a CSP's first KMS provisioning service 304. The request can indicate that the replicated encrypted keys are to be transmitted from the primary region 306 to a secondary region 308. The primary region 306 can include a data center that includes one or more servers. The first KMS provisioning service 304 can be a vault replicating service that executes on one or more servers of the data center in the primary region 306.

In response to receiving the request, the first KMS provisioning service 304 can transmit a query to a second KMS provisioning service 402 of the secondary region 308 to determine whether the second KMS provisioning service 402 has the capacity to replicate a vault with the replicated encrypted keys in the secondary region 308. Similar to the first KMS provisioning service 304, the second KMS provisioning service 402 can be a vault replicating service that executes on one or more servers of the data center in the secondary region 308. The second KMS provisioning service 402 can assess the data center's server and storage resources (e.g., processing capability, memory, network bandwidth, or other appropriate resources) to determine whether there is the capacity to create a vault with the replicated encrypted keys in the secondary region 308. In some embodiments, the second KMS provisioning service 402 can query each HMS of the data center in the secondary region 308 to determine which, if any, HMS has the capacity to store a vault. If the second KMS provisioning service 402 does not have the capacity, it will transmit a response to the first KMS provisioning service 304 indicating the lack of capacity. If, however, the second KMS provisioning service 402 does have the capacity, it will transmit a response to the first KMS provisioning service 304 indicating that it has the capacity.

If the second KMS provisioning service 402 indicates the lack of capacity, the first KMS provisioning service 304 transmit an indication to the user device 302 of the lack of capacity, or the first KMS provisioning service 304 can wait for a period of time and transmit another query to a second KMS provisioning service 402 to determine whether the second KMS provisioning service 402 has the capacity to create the vault with the replicated encrypted keys in the secondary region 308. This process can repeat itself until the second KMS provisioning service 402 indicates that it has the capacity.

If the second KMS provisioning service 402 indicates that the secondary region 308 has the capacity, then the first KMS provisioning service 304 can store the request to create the vault and vault-related information (e.g., vault identifier, vault memory address, or other appropriate vault-related information) in the first database 310. By storing the request and the vault-related information, the first KMS provisioning service 304 can create a record of the creation of the vault in the secondary region 308. It should be appreciated that although the primary region 306 is illustrated as including a single first database 310, each HMS card in the data center of the primary region 306 can be associated with a respective database. For example, if the data center in the primary region 306 includes ten HSMs, each HSM can be associated with a respective database.

The first asynchronous daemon 312 can process the request from the user device 302 based on the second KMS provisioning service 402 indicating that it has the capacity. For example, the first asynchronous daemon 312 can access the request to create a virtual vault, and also virtual vault-related information from the first database 310. The first asynchronous daemon 312 can then transmit the request to create the vault, and also transmit the vault-related information to the second KMS provisioning service 402 in the secondary region 308.

The second KMS provisioning service 402 can store the request to create the vault, and also the vault-related information in a second database 404 at a data center in the secondary region 308. The second database 404 can be considered a persistent data store for storing vault metadata and HSM metadata. A second asynchronous daemon 406 (e.g., a vault state updater) executing in the second KMS provisioning service 402 can access the request to create the vault, and also the vault-related information from the second database 404. The second asynchronous daemon 406 can be a vault state updater. The vault information can include metadata, such as routing information, domain name server information, key information, and other appropriate information.

Based on the request to create the vault and vault-related information, the second asynchronous daemon 406 can transmit a request to create the vault and transmit the vault-related information to a KMS control plane service 408. The second KMS provisioning service 402 and the KMS control plane service 408 each perform a function for creating the vault on an HMS in the data center in the secondary region 308. For example, the second KMS provisioning service 402 can determine routing information to be used to access the vault, and also update the domain name server (DNS) information to be used to access the vault. The KMS control plane service 408 can create metadata to be used for the vault to function. The metadata can include the vault identifier (ID), the wrapping keys, intermediate encryption keys, and other appropriate metadata.

The second asynchronous daemon 406 can store the request to create the vault and vault-related information from the second asynchronous daemon 406 into the second database 404. In some embodiments, both the request to create the vault and the vault-related information from the second asynchronous daemon 406 can be stored in the same record as the request to create the vault and vault-related information from the first asynchronous daemon 312.

It should be appreciated that for each data center in a region (e.g., secondary region 308) there may be only one KMS provisioning service (e.g., second KMS provisioning service 402) and multiple KMS control plane services, including the KMS control plane service 408. The number of KMS control plan service instances can correspond to the number of HMS shards being used at the data center. For example, if there are ten HMSs being used at the data center, there can be ten KMS control plan service instances. For each data center, the KMS provisioning service can communicate with each of the KMS control plan service instances. Therefore, each KMS control plan service instance can communicate with a respective HMS. Furthermore, each HMS can be associated with a respective database.

The KMS control plane service 408 can transmit a request to create a partition and a WAL for an HSM to a KMS HSM agent 410. The KMS HSM agent 410 can be associated with a service that manages an HSM. The HSM can be the HSM that corresponds to the KMS control plane service 408. This step can be based on whether the partition is going to be a shared space or a private. For example, a virtual vault can be stored in a shared partition on the HSM that incudes other virtual vaults. On the other hand, a virtual private vault does not share a partition on the HSM with other vaults. If the vault is a virtual vault to be in a shared partition, the KMS HSM agent 410 does not create a hardware resource for the partition. Rather the KMS HSM agent can create a mapping from the vault to an existing hardware resource. If the vault is a virtual private vault in a private partition, then the KMS HSM can create a hardware resource and a mapping to the hardware resource.

A third asynchronous daemon 412 (e.g., a partition replication state manager) can store the request to create a partition and a WAL in the second database 404. In some embodiments, the request to create the partition and the WAL can be stored in the same record as the request to create the vault and vault-related information from the second asynchronous daemon 406 and the request to create the vault and vault-related information from the first asynchronous daemon 312. In this sense, information to be used to create the vault can be accessed from a single location.

The KMS control plane service 408 can access the request to create the vault and vault-related information from the second database 404. The third asynchronous daemon 412 can analyze the request to determine whether the requested vault is a virtual vault. For example, in some instances, the requested vault can be a virtual private vault, which is already configured for a single customer. If, however, the requested vault is a virtual vault, then the third asynchronous daemon 412 can set up a CPDP WAL, similar to the first WAL 122, second WAL 124, or Nth WAL 126. The third asynchronous daemon 412 can further set up a virtual partition WAL, similar to the first virtual partition WAL 202, second virtual partition WAL 204, or Nth virtual partition WAL 206. The virtual partition WAL can map to a virtual vault partition at the secondary region. For example, a second HSM at a second data center at the secondary region can be mapped to the virtual partition WAL.

The third asynchronous daemon 412 can store an indication in the second database 404 that the virtual vault is ready to store encryption keys. The second asynchronous daemon 406 can then indicate to the first asynchronous daemon 312 that the virtual vault at the secondary region 308 is ready to store encryption keys. In response, the first asynchronous daemon 312 can then respond by transmitting a replication of the virtual partition WAL at the primary region 306 that is storing the encryption keys to the second asynchronous daemon 406. The second asynchronous daemon 406 can transmit the replicated virtual partition WAL to the fourth asynchronous daemon 414. The fourth asynchronous daemon 414 can store the replicated encryption keys from the replicated virtual partition WAL in a virtual partition of an HSM at the secondary region 308. The encryption keys can then be made available for the customer's use at the secondary region 308.

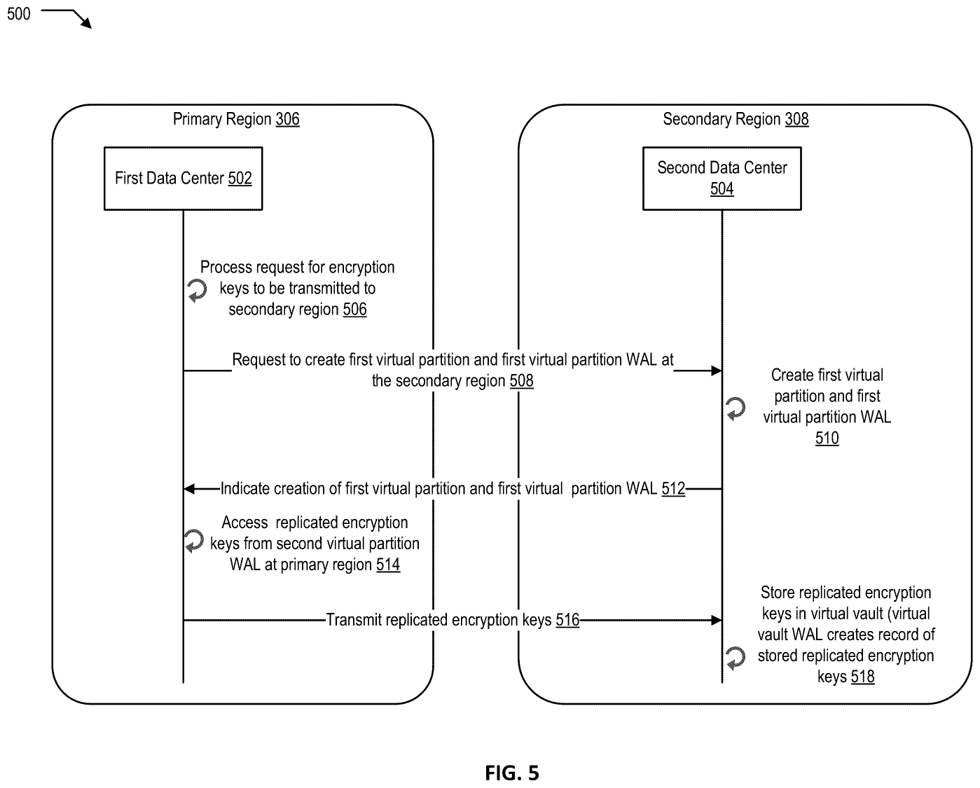

FIG. 5 is a signaling diagram 500 for replicating keys from a primary region to a secondary region, according to one or more embodiments. While the operations of processes 500 and 600 are described as being performed by generic computers, it should be understood that any suitable device may be used to perform one or more operations of these processes. Processes 500 and 600 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 506 a first data center 502 at the primary region 306 can process a request for encryption keys to be transmitted to a secondary region 308. For example, a CSP customer can use a user device (e.g., user device 302) to request that the customer's encryption keys be moved to the secondary region 308. The encryption keys can be stored on a first HSM of the first data center 502. The request can be processed by a KMS provisioning service (e.g., KMS provisioning service 304).

At 508, the first data center 502 can transmit a request to the second data center 504 to create a first virtual partition and first virtual partition WAL of the second data center 504. For example, a first KMS provisioning service (e.g., first KMS provisioning service 304) can transmit a request to a second KMS provisioning service (e.g., second KMS provisioning service 402) to determine whether there is the capacity to create the first virtual partition and the first virtual partition WAL at the second data center 504. The second KMS provisioning service can query each HSM of the second data center 504 and determine whether there is the capacity to create the first virtual partition and the first virtual partition WAL.

At 510, assuming the capacity exists, the second data center 504 can create a first virtual partition and the first virtual partition WAL. For example, an HSM agent (e.g., KMS HSM agent 410) can cause the first virtual partition and the first virtual partition WAL 202 to be created at an HSM at the second data center 504. The HSM agent can further cause the first virtual partition and the first virtual partition WAL to be mapped to a virtual vault partition, which can include physical storage of the HSM.

At 512, the second data center 504 can transmit an indication to the first data center 502 that the first virtual partition and the first virtual partition WAL have been created. For example, the second KMS provisioning service can transmit the indication to the first KMS provisioning service that the first virtual partition and the first virtual partition WAL have been created.

At 514, the second data center 504 can access replicated encryption keys from a virtual partition WAL (e.g., first virtual partition WAL 202, second virtual partition WAL 204, or Nth virtual partition WAL 206). In some instances, the first KMS provisioning service can access the entire virtual partition WAL and transmit the virtual partition WAL to the second KMS provisioning service.

At 516, the second data center 504 stored the replicated encryption keys in a virtual vault at the second data center 504. For example, a KMS HMS agent (e.g., KMS HMS agent 410) can cause the encryption keys received from the first KMS provisioning service to be stored in the virtual vault of an HSM at the second data center 504.

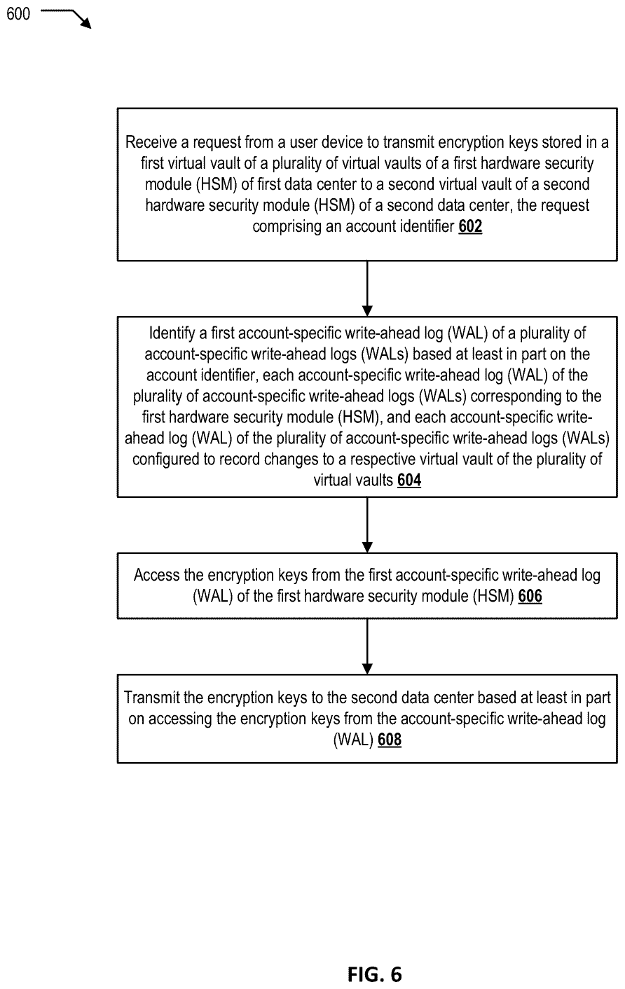

FIG. 6 is a process 600 for replicating keys from a primary region to a secondary region, according to one or more embodiments. At 602, the process 600 can include a computing system receiving a request from a user device to transmit encryption keys stored in a first virtual vault of a plurality of virtual vaults at a first HSM (e.g., HSM 102) at a first data center to a second virtual vault at a second HSM at a second data center. The first virtual vault can map to a physical partition at the first HSM, where the encryption keys are stored in the physical partition. The computing system can include a first data center (e.g., first data center 502) at a primary region (e.g., primary region 306).

A user (e.g., CSP customer) can use a user device (e.g., user device 302) to make the request to transmit replicating encryption keys from the primary region to a secondary region (e.g., secondary region 308). The request can include an account identifier that can be used to identify an account-specific virtual partition WAL (e.g., first virtual partition WAL 202, second virtual partition WAL 204, or Nth virtual partition WAL 206). The account identifier can be associated with the user's account with the CSP.

At 604, the process 600 can include the computing system identifying a first account-specific WAL of a plurality of account-specific WALs based on the account identifier, each account-specific WAL of the plurality of account-specific WALs corresponding to the first HSM. Each account-specific WAL of the plurality of account-specific WALs configured record changes to a respective virtual vault of the plurality of virtual vaults.

At 606, the process 600 can include the computing system accessing the encryption keys from the first account-specific WAL from the first HSM.

In some embodiments, computing system can transmit a first message to the second data center as to whether the second data center has the capacity to generate a second virtual vault for storing the encryption keys. The second virtual vault of the second data center can correspond to the first account-specific virtual vault. A KMS provisioning service (e.g., second KMS provisioning service 402) can query each HSM of the second data center to determine whether any HSM has the capacity for a second account-specific virtual vault.

Assuming at least one HSM has the capacity, the KMS provisioning service can transmit a second message indicating that it has the capacity for the second account-specific virtual vault. A KMS provisioning service (e.g., first KMS provisioning service) can receive the second message indicating that the second data center has the capacity to generate a second virtual vault for storing the encryption keys. The KMS provisioning service can access the encryption keys from the first account-specific WAL based at least in part on the second message.

At 608, the process 600 can include the computing transmitting the encryption keys to the second data center based at least in part on the encryption keys from the customer-specific WAL. The KMS provisioning service of the first data center can receive a third message from the second data center that the second virtual vault has been generated. The encryption keys can be transmitted to the second data center based on this third message.

In some embodiments, an HSM agent (e.g., HSM agent 106) can detect the initial generation of a first virtual partition (e.g., first virtual partition 108, second virtual partition 110, or Nth virtual partition 112) at a virtual vault partition (e.g., virtual vault partition 104) of the first HSM, where the first virtual partition corresponds to the first virtual vault. The HSM agent can cause a masking key to be generated based on the detecting generation of the first virtual partition. The same masking key can be generated at the second HSM of the second data center of the secondary region. The HSM agent can further cause the encryption keys to be encrypted using the masking key. The encryption keys can then be decrypted at the second data center using the same masking key.

At some time after creation of the first virtual vault, the HSM agent of the primary region can detect an update to the contents of the virtual vault. The update can include inserting an encryption key into the virtual vault, modifying an encryption key of the virtual vault, or deleting an encryption key from the virtual vault. The HSM agent can further cause the first account-specific WAL to create a log entry that reflects the update. In these instances, the encryption keys that are transmitted to the secondary region can be the updated encryption keys.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

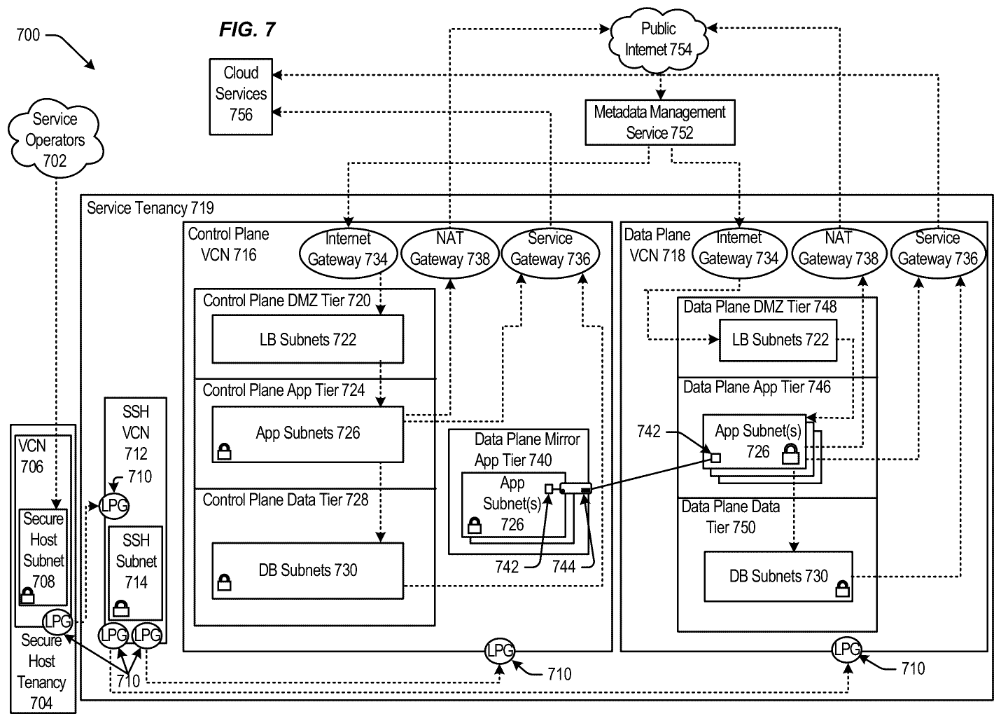

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

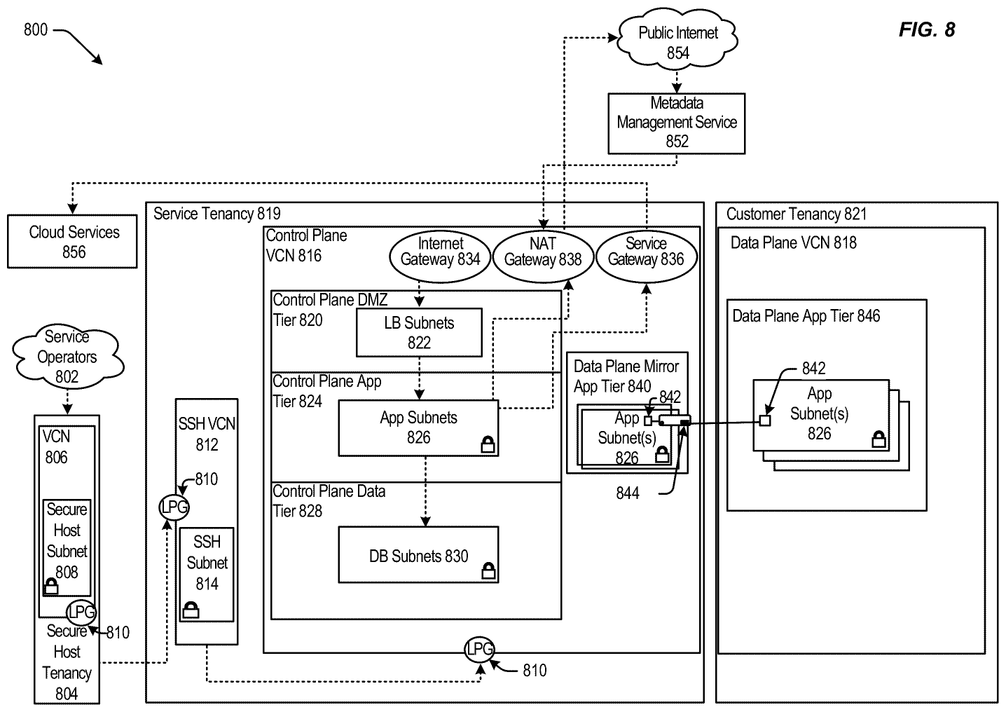

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

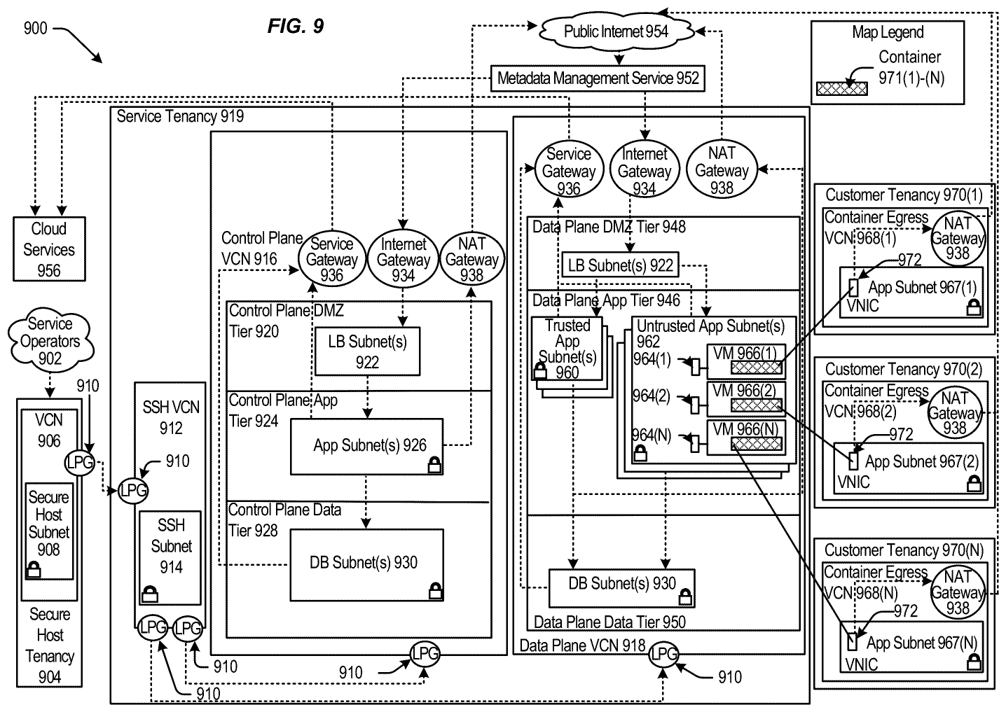

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

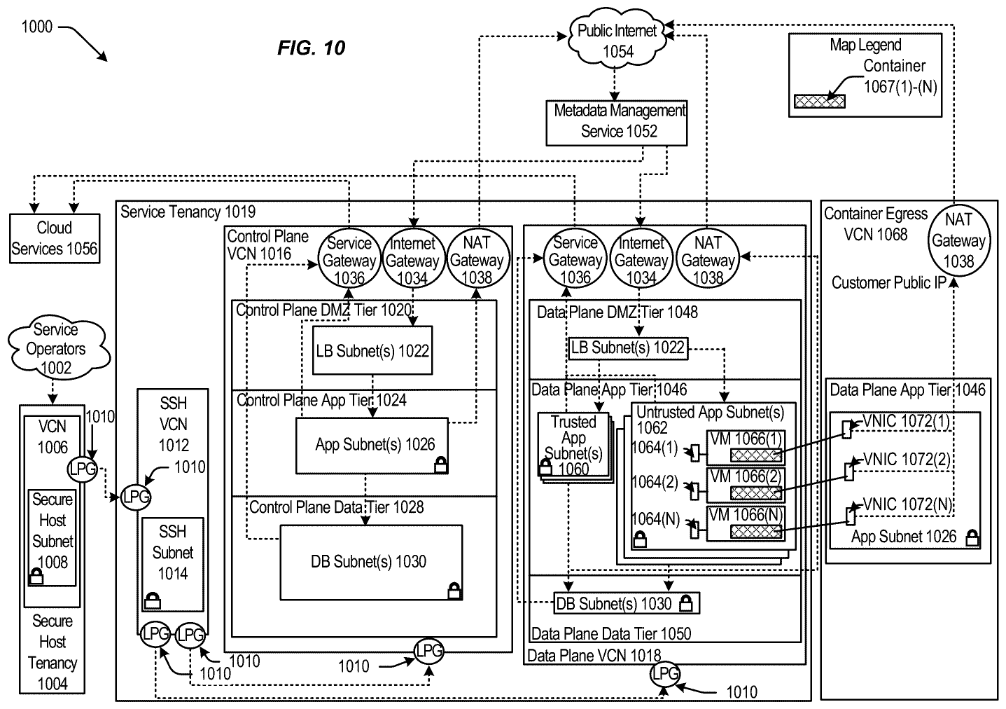

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

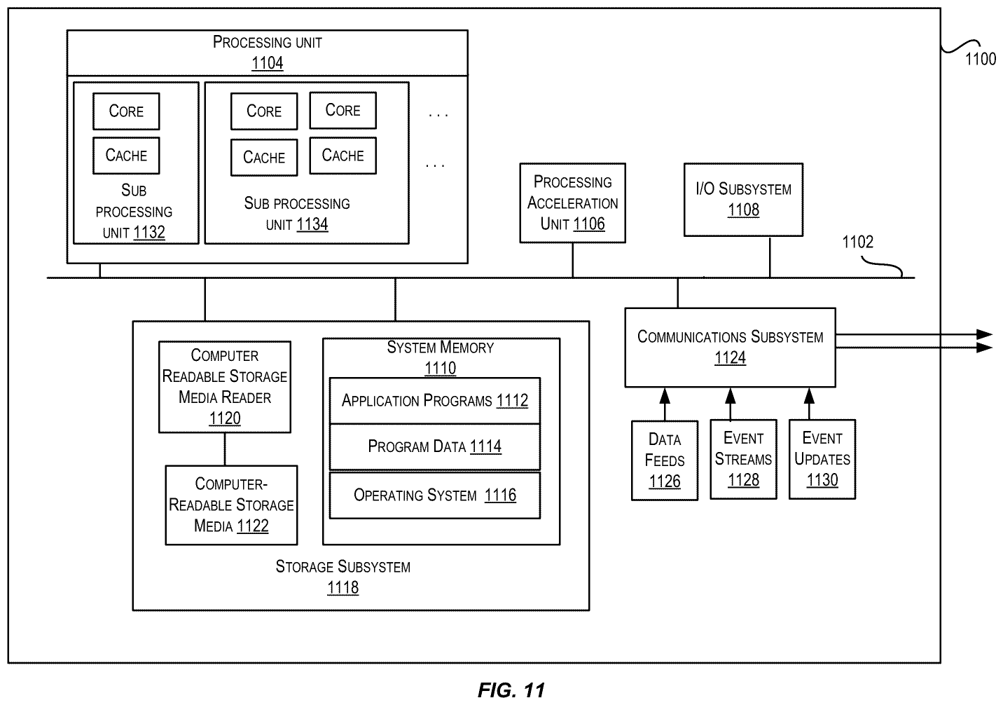

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a computing system, a request from a user device to transmit encryption keys stored in a first virtual vault of a plurality of virtual vaults of a first hardware security module (HSM) of a first data center to a second virtual vault of a second hardware security module (HSM) of a second data center, the request comprising an account identifier;
identifying, by the computing system, a first account-specific write-ahead log (WAL) of a plurality of account-specific write-ahead logs (WALs) based at least in part on the account identifier, each account-specific write-ahead log (WAL) of the plurality of account-specific write-ahead logs (WALs) corresponding to the first hardware security module (HSM), and each account-specific write-ahead log (WAL) of the plurality of account-specific write-ahead logs (WALs) configured to record changes to a respective virtual vault of the plurality of virtual vaults;
accessing, by the computing system, the encryption keys from the first account-specific write-ahead log (WAL) of the first hardware security module (HSM); and
transmitting, by the computing system, the encryption keys to the second data center based at least in part on accessing the encryption keys from the account-specific write-ahead log (WAL).

2. The method of claim 1, wherein the method further comprises:
detecting generation of a first virtual partition at a virtual vault partition of the first hardware security module (HSM), the first virtual partition corresponding to the first virtual vault;
generating a masking key based at least in part on detecting the generation of the first virtual partition; and
encrypting the encryption keys using the masking key, wherein the encryption keys can be decrypted at the second data center using the same masking key.

3. The method of claim 1, wherein the method further comprises:
transmitting, to the second data center, a first message as to whether the second data center has a capacity to generate a second virtual vault for storing the encryption keys; and
receiving a second message indicating that the second data center has the capacity to generate a second virtual vault for storing the encryption keys, wherein the encryption keys are accessed from the first account-specific write-ahead log (WAL) based at least in part on the second message.

4. The method of claim 3, wherein the method further comprises:
receiving a third message from the second data center that the second virtual vault has been generated, wherein the encryption keys are transmitted to the second data center based at least in part on the third message.

5. The method of claim 1, wherein the method further comprises:
detecting an update of the encryption keys at the first virtual vault; and
causing the first account-specific write-ahead log (WAL) to create a log entry describing the update, wherein the updated encryption keys are transmitted to the second data center.

6. The method of claim 5, wherein the update comprises at least one of inserting an encryption key into the first virtual vault, modifying an encryption key at the first virtual vault, or deleting an encryption key from the first virtual vault.

7. The method of claim 1, wherein the first virtual vault maps to a physical partition of the first hardware security module (HSM).

8. A computing system, comprising:
one or more processors; and
one or more computer-readable media having stored thereon a sequence of instructions that, when executed, cause the one or more processors to:
receive a request from a user device to transmit encryption keys stored in a first virtual vault of a plurality of virtual vaults of a first hardware security module (HSM) of a first data center to a second virtual vault of a second hardware security module (HSM) of a second data center, the request comprising an account identifier;
identify a first account-specific write-ahead log (WAL) of a plurality of account-specific write-ahead logs (WALs) based at least in part on the account identifier, each account-specific write-ahead log (WAL) of the plurality of account-specific write-ahead logs (WALs) corresponding to the first hardware security module (HSM), and each account-specific write-ahead log (WAL) of the plurality of account-specific write-ahead logs (WALs) configured to record changes to a respective virtual vault of the plurality of virtual vaults;
access the encryption keys from the first account-specific write-ahead log (WAL) of the first hardware security module (HSM); and
transmit the encryption keys to the second data center based at least in part on accessing the encryption keys from the account-specific write-ahead log (WAL).

9. The computing system of claim 8, wherein the sequence of instructions, when executed, further cause the one or more processors to:
detect generation of a first virtual partition at a virtual vault partition of the first hardware security module (HSM), the first virtual partition corresponding to the first virtual vault;
generate a masking key based at least in part on detecting the generation of the first virtual partition; and
encrypt the encryption keys using the masking key, wherein the encryption keys can be decrypted at the second data center using the same masking key.

10. The computing system of claim 8, wherein the sequence of instructions, when executed, further cause the one or more processors to:
transmit, to the second data center, a first message as to whether the second data center has a capacity to generate a second virtual vault for storing the encryption keys; and
receive a second message indicating that the second data center has the capacity to generate a second virtual vault for storing the encryption keys, wherein the encryption keys are accessed from the first account-specific write-ahead log (WAL) based at least in part on the second message.

11. The computing system of claim 10, wherein the sequence of instructions, when executed, further cause the one or more processors to:
receive a third message from the second data center that the second virtual vault has been generated, wherein the encryption keys are transmitted to the second data center based at least in part on the third message.

12. The computing system of claim 8, wherein the sequence of instructions, when executed, further cause the one or more processors to:
detect an update of the encryption keys at the first virtual vault; and
cause the first account-specific write-ahead log (WAL) to create a log entry describing the update, wherein the updated encryption keys are transmitted to the second data center.

13. The computing system of claim 12, wherein the update comprises at least one of inserting an encryption key into the first virtual vault, modifying an encryption key at the first virtual vault, or deleting an encryption key from the first virtual vault.

14. The computing system of claim 8, wherein the first virtual vault maps to a physical partition of the first hardware security module (HSM).

15. One or more non-transitory computer-readable media having stored thereon a sequence of instructions that, when executed by one or more processors of a computing system, cause the computing system to:
receive a request from a user device to transmit encryption keys stored in a first virtual vault of a plurality of virtual vaults of a first hardware security module (HSM) of a first data center to a second virtual vault of a second hardware security module (HSM) of a second data center, the request comprising an account identifier;
identify a first account-specific write-ahead log (WAL) of a plurality of account-specific write-ahead logs (WALs) based at least in part on the account identifier, each account-specific write-ahead log (WAL) of the plurality of account-specific write-ahead logs (WALs) corresponding to the first hardware security module (HSM), and each account-specific write-ahead log (WAL) of the plurality of account-specific write-ahead logs (WALs) configured to record changes to a respective virtual vault of the plurality of virtual vaults;
access the encryption keys from the first account-specific write-ahead log (WAL) of the first hardware security module (HSM); and
transmit the encryption keys to the second data center based at least in part on accessing the encryption keys from the account-specific write-ahead log (WAL).

16. The one or more non-transitory computer-readable media of claim 15, wherein the sequence of instructions, when executed, further cause the one or more processors to:
detect generation of a first virtual partition at a virtual vault partition of the first hardware security module (HSM), the first virtual partition corresponding to the first virtual vault;
generate a masking key based at least in part on detecting the generation of the first virtual partition; and
encrypt the encryption keys using the masking key, wherein the encryption keys can be decrypted at the second data center using the same masking key.

17. The one or more non-transitory computer-readable media of claim 15, wherein the sequence of instructions, when executed, further cause the one or more processors to:
transmit, to the second data center, a first message as to whether the second data center has a capacity to generate a second virtual vault for storing the encryption keys; and
receive a second message indicating that the second data center has the capacity to generate a second virtual vault for storing the encryption keys, wherein the encryption keys are accessed from the first account-specific write-ahead log (WAL) based at least in part on the second message.

18. The one or more non-transitory computer-readable media of claim 17, wherein the sequence of instructions, when executed, further cause the one or more processors to:
receive a third message from the second data center that the second virtual vault has been generated, wherein the encryption keys are transmitted to the second data center based at least in part on the third message.

19. The one or more non-transitory computer-readable media of claim 15, wherein the sequence of instructions, when executed, further cause the one or more processors to:
detect an update of the encryption keys at the first virtual vault; and
cause the first account-specific write-ahead log (WAL) to create a log entry describing the update, wherein the updated encryption keys are transmitted to the second data center.

20. The one or more non-transitory computer-readable media of claim 19, wherein the update comprises at least one of inserting an encryption key into the first virtual vault, modifying an encryption key at the first virtual vault, or deleting an encryption key from the first virtual vault.
